(19) United States
(12) Patent Application Publication
(10) Pub. No.: US 2012/0300259 A1
(43) Pub. Date: Nov. 29, 2012

(54) INFORMATION ADDING DEVICE, ELECTRONIC CAMERA, INFORMATION ADDING PROGRAM

(75) Inventors: Hiroki Hosaka, Yokohama-shi (JP); Jun Konno, Tokyo (JP); Miho Hara, Chigasaki-shi (JP); Kenji Tonegawa, Tokyo (JP)

(73) Assignee: NIKON CORPORATION, Tokyo (JP)

(21) Appl. No.: 13/576,264

(22) PCT Filed: Jan. 27, 2011
(86) PCT No.: PCT/JP2011/051575

§ 371 Date: Jul. 31, 2012

(30) Foreign Application Priority Data
Feb. 1, 2010 (JP) 2010-020423

(51) Int. Cl. G06K 9/62; G06F 15/00

(52) U.S. Cl. 358/1.15; 382/224

(57) ABSTRACT

When a rating setting dial is turned in a second direction while setting an evaluation ranking for a captured image displayed on a rating screen, an MPU lowers the evaluation ranking set for said captured image while adding the corresponding evaluation ranking information to the image file of the captured image. In addition, when the rating setting dial is further turned in the second direction while the evaluation ranking set for the captured image is at the lowest evaluation ranking, the MPU adds deletion candidate specifying information, which enables the identification of said captured image as a deletion candidate file, to the image file of the captured image.

### TECHNICAL FIELD

The present invention relates to an information adding device that can add to a data file, such as an image file, plural pieces of information including at least evaluation ranking information about the of the data file, an electronic camera including such an information adding device, and an information adding program.

### BACKGROUND ART

Typical electronic cameras, such as digital still cameras, can show captured images on their backside LCD monitor screens. A recently proposed electronic camera includes a rating function that sets rating information (evaluation ranking information) for a captured image. The rating information is used as an evaluation ranking of a captured image (refer to, for example, patent document 1).

### PRIOR ART DOCUMENTS

Patent Documents
Patent Document 1: Japanese Laid-Open Patent Publication No. 2008-3404

### DISCLOSURE OF THE INVENTION

### Problem to be Solved by the Invention

When a user is rating a plurality of captured images, the user may set rating information so that unnecessary images that should be deleted can be found rather than saved and managed. In such a case, with the conventional electronic camera, the displayed screen is switched from a rating screen to a deletion screen, and then captured images are sequentially switched and displayed on the deletion screen so that the user can search for the unnecessary images found during the rating. Whenever finding an unnecessary image, the user operates an operation component that completely differs from the component used during the rating. In this manner, the conventional electronic camera requires the user to perform a complicated operation for deleting unnecessary images found during rating.

Such a problem also occurs in an information adding device that adds data file evaluation rank information and non-rating processing information to a data file. Non-rating processing information is used to perform a non-rating process (e.g., transferring, printing, or the like) that differs from an evaluation rank recognition process based on the evaluation rank information.

Accordingly, it is an object of the present invention to provide an information adding device, an electronic camera, and an information adding program that promptly and easily adds, to a data file, evaluation ranking information, which allows for recognition of an evaluation ranking of the data file, and non-rating processing information, which is used to perform a non-rating process that differs from an evaluation ranking recognition process based on the evaluation ranking information.

### Means for Solving the Problems

To achieve the above object, an information adding device according to the present invention includes an evaluation ranking information adding means for setting evaluation ranking information for a data file. The evaluation ranking information can be used in recognition processing of an evaluation ranking of the data file. The evaluation ranking information adding means performs rating processing to raise the evaluation ranking in response to a first operation, performs rating processing to lower the evaluation ranking in response to a second operation that differs from the first operation, and adds evaluation ranking information to the data file in accordance with the result of the rating processing performed. A processing information adding means adds non-rating processing information to the data file when the first operation is further performed in a state in which the evaluation ranking is a highest ranking or when the second operation is further performed in a state in which the evaluation ranking is a lowest ranking. The non-rating processing information is used to perform non-rating processing that differs from the recognition processing of the evaluation ranking.

In one example, the processing information adding means adds deletion candidate designation information as the non-rating processing information to the data file when the second operation is performed in a state in which the evaluation ranking is the lowest evaluation ranking. The deletion candidate designation information allows for the data file to be recognized as a deletion candidate file.

In one example, the processing information adding means adds deletion designation information as the non-rating processing information to the data file when the second operation is performed in a state in which the evaluation ranking is the lowest evaluation ranking. The deletion designation information allows for the data file to be recognized as a deletion file.

In one example, the data file is deleted when a third operation is further performed for the data file to which the deletion candidate designation information has been added.

In one example, the processing information adding means adds protection information or transfer information as the non-rating processing information to the data file when the first operation is performed in a state in which the evaluation ranking is the highest evaluation ranking. The protection information indicates that the data file is a file subject to protection, and the transfer information indicates that the data file is subject to transfer to an external device.

In one example, the data file is an image file. The processing information adding means adds printing information as the non-rating processing information to the data file when the first operation is performed in a state in which the evaluation ranking is the highest evaluation ranking. The printing information indicates that the data file is subject to printing.

In one example, the information adding device further includes an operating member that is turned to perform the first operation and the second operation. The first operation is an operation that turns the operating member in a first direction. The second operation is an operation that turns the operating member in a second direction.

In one example, the information adding device further includes a display means including a screen that can display an evaluation ranking indication mark indicating the evaluation ranking and a processing content indication mark corresponding to the non-rating processing information. A display control means changes a size of a display area of the evaluation ranking indication mark on the screen in a predetermined direction in accordance with the evaluation ranking and displays the processing content indication mark at a position adjacent to the display area of the evaluation ranking indication mark in the predetermined direction.

In one example, the display means is a touch panel. The evaluation ranking information adding means and the processing information adding means detect the first operation and the second operation based on a signal provided from the touch panel in correspondence with movement of a finger on the touch panel.

In one example, the display means displays an additional information display section that displays the evaluation ranking indication mark and the processing content indication mark in a single row or in a plurality of rows.

In one example, the additional information display section displays the evaluation ranking indication mark and the processing content indication mark in a single row.

In one example, the additional information display section includes a plurality of rows that can display the evaluation ranking indication mark and a plurality of processing content indication marks respectively corresponding to a plurality of non-rating processing contents.

In one example, the plurality of rows of the additional information display section are displayed one by one in response to operation of an operating member.

In one example, the plurality of rows of the additional information display section include a first row, which displays the evaluation ranking indication mark, and a second row, which displays at least one of the plurality of processing content indication marks.

In one example, the additional information display section can display a plurality of processing content indication marks respectively corresponding to a plurality of non-rating processing contents. The plurality of processing content indication marks include a printing icon, a protection icon, and a transfer icon. When the first operation is further performed in a state in which the evaluation ranking is the highest evaluation ranking, one of the printing icon, the protection icon, and the transfer icon is selected in accordance with an operation amount of the first operation.

In one example, the display means can display a list of a plurality of data file marks respectively corresponding to a plurality of data files. The display control means displays the evaluation ranking indication mark or the processing content indication mark corresponding to a data file mark selected from the list of the plurality of data file marks displayed on the screen.

In one example, the information adding device further includes a selection means for freely selecting a plurality of data files from the list of the plurality of data file marks displayed on the screen. The evaluation ranking information adding means adds the same evaluation ranking information to the selected data files. The processing information adding means adds the same non-rating processing information to the selected data files.

In one example, the processing information adding means adds the non-rating processing information to the data file when the first operation is further performed a number of times in a state in which the evaluation ranking is the highest evaluation ranking or when the second operation is further performed a number of times in a state in which the evaluation ranking is the lowest evaluation ranking.

In one example, the data file is an image file.

Another aspect of the present invention provides an electronic camera including an imaging means for capturing an image and the information adding device of the above configuration.

A further aspect of the present invention provides an information adding program executed by an information adding device configured to be able to add evaluation ranking information and non-rating processing information to a data file. The evaluation ranking information allows for recognition of an evaluation ranking of the data file, and the non-rating processing information is used to perform non-rating processing that differs from a recognition processing of the evaluation ranking. The program causes the information adding device to execute an evaluation ranking information adding step including a rating process that raises the evaluation ranking in response to a first operation, a rating process that lowers the evaluation ranking in response to a second operation that differs from the first operation, and a process that adds evaluation ranking information to the data file in accordance with the result of the rating processes performed. The program also causes the information adding device to execute a processing information adding step that adds the non-rating processing information to the data file when the first operation is further performed in a state in which the evaluation ranking is a highest evaluation rank or when the second operation is further performed in a state in which the evaluation ranking is a lowest evaluation rank.

### Effect of the Invention

The present invention promptly and easily adds, to a data file, evaluation ranking information, which allows for recognition of an evaluation ranking of the data file, and non-rating processing information, which is used to perform a non-rating process that differs from an evaluation ranking recognition process based on the evaluation ranking information.

### BRIEF DESCRIPTION OF THE DRAWINGS

FIG. 1 is a rear view of a digital camera;

FIG. 2 is a block diagram showing the internal structure of the digital camera;

FIG. 3 is a diagram showing the contents displayed in a screen on a monitor when a rating switching button is pushed during a reproduction mode;

FIG. 4 is a diagram showing the contents displayed in a screen on the monitor when an image is being rated;

FIG. 5 is a diagram showing the contents displayed in a screen on the monitor when an enter button is pushed in the screen display state of FIG. 4;

FIG. 6 is a diagram showing the contents displayed in a screen on the monitor when a deletion candidate designation process is being performed on an image;

FIG. 7 is a diagram showing the contents displayed in a screen on the monitor when the enter button is pushed in the screen display state of FIG. 6;

FIG. 8 is a diagram showing the contents displayed in a screen on the monitor when a zoom button is pushed in a reduction direction in the screen display state of FIG. 5;

FIG. 9 is a diagram showing the contents displayed in a screen on the monitor when the rating switching button is pushed in the screen display state of FIG. 8;

FIG. 10 is a diagram showing the contents displayed in a screen on the monitor when a displayed thumbnail image is being rated;

FIG. 11 is a diagram showing the contents displayed in a screen on the monitor when the enter button is pushed in the screen display state of FIG. 10;

FIG. 12 is a diagram showing the contents displayed in a screen on the monitor of a digital camera in a first modification;

FIG. 13 is a diagram showing the contents displayed in a screen on the monitor of a digital camera in a second modification;

FIG. 14 is a diagram showing the contents displayed in a screen on the monitor of a digital camera in a third modification; and

FIG. 15 is a diagram showing the contents displayed in a screen on the monitor of a digital camera in a fourth modification.

### EMBODIMENTS OF THE INVENTION

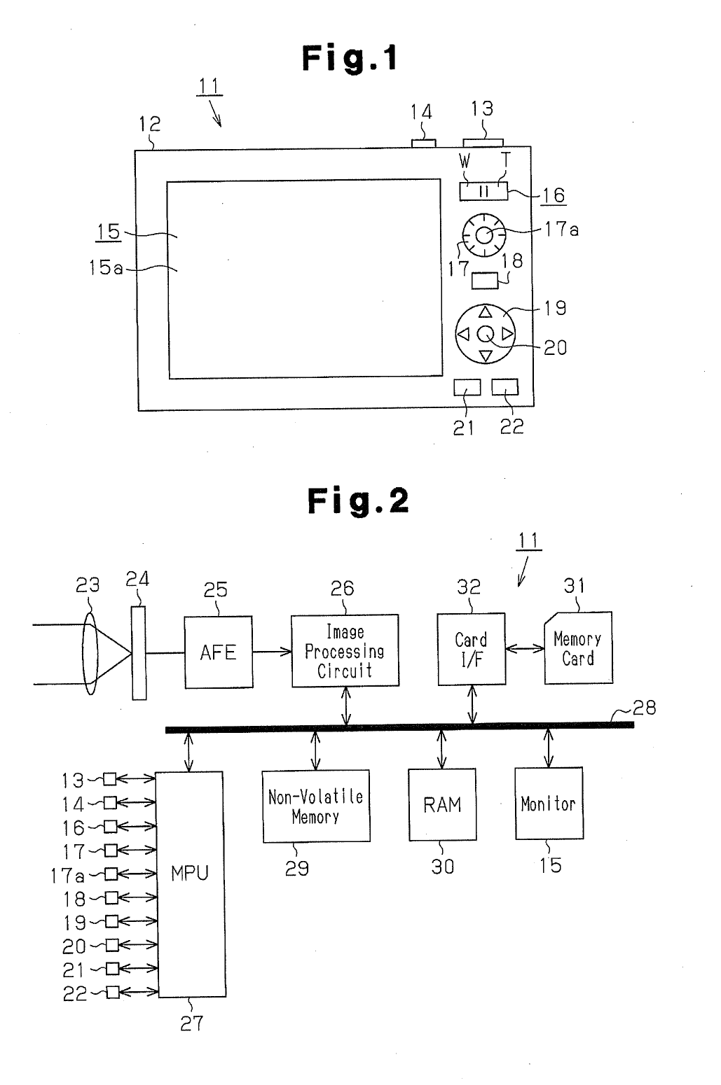

A digital still camera (hereafter, referred to as the “camera”), which is one type of electronic camera, an information adding device included in the camera, and an information adding program used by the information adding device according to one embodiment of the present invention will now be described with reference to FIGS. 1 to 11.

As shown in FIG. 1, the camera 11 of the present embodiment includes a camera unit 12, which is generally box-shaped. A shutter-release button 13 arranged on the upper right surface of the camera unit 12 is pushed by a photographer to capture an image of a subject with the camera 11. A power button 14 arranged on the upper surface of the camera unit 12 at the left side of the shutter-release button 13 is pushed by the photographer to activate the camera 11.

An LCD monitor (hereafter, referred to as the “monitor”) 15, which functions as display means and includes a tetragonal screen 15a, is arranged in the rear side of the camera unit 12 substantially occupying the entire rear surface of the camera unit 12 excluding the portion toward the right end. Different types of buttons operated by the photographer are arranged in the area at the right side of the screen 15a of the monitor 15.

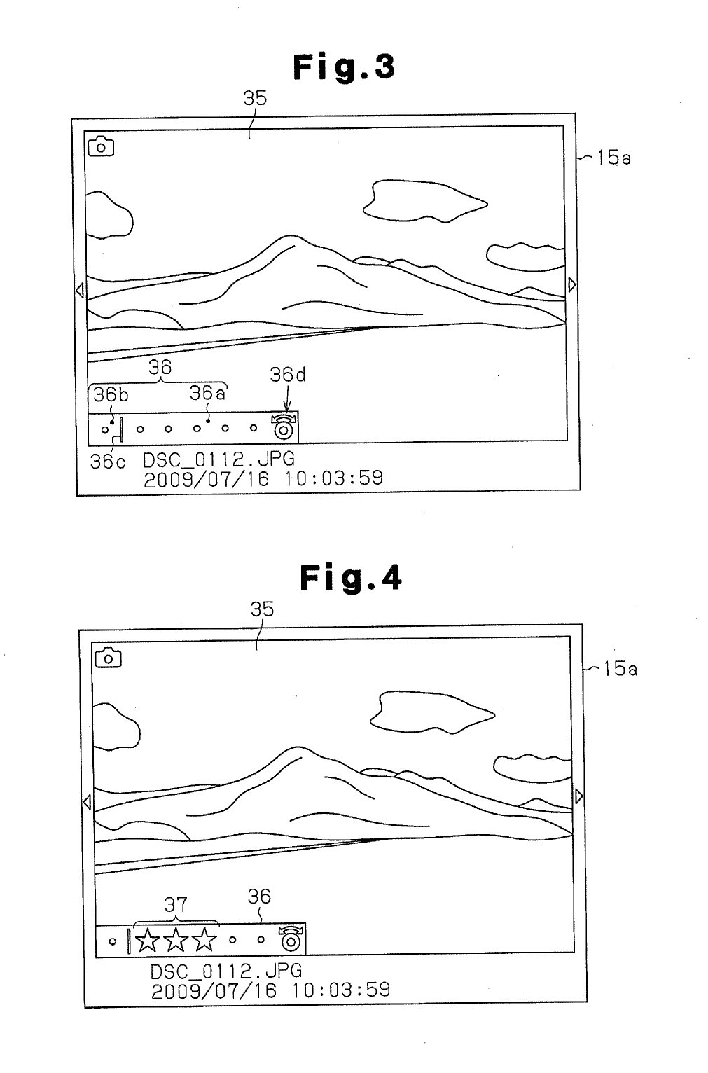

In the area at the right side of the screen 15a of the monitor 15, a zoom button 16 is arranged at the top. Below the zoom button 16, a rating setting dial 17, a rating switching button 17a, a mode switch button 18, a select button 19, an enter button 20, a menu button 21, and a delete button 22 are arranged. The zoom button 16 is pushed during an image capturing mode to mainly capture an image of a subject at a wide angle or telephoto. The zoom button 16 is also pushed during a reproduction mode to switch the display state of a captured image (hereinafter, may be referred to as the “image”) 35 (refer to FIG. 3 etc.) on the screen 15a of the monitor 15 between a magnified display and a reduced display.

The rating switching button 17a is pushed during the reproduction mode to switch the screen 15a of the monitor 15 between a normal reproduction display screen and a rating screen (refer to FIG. 3), which allows for the captured image 35 that is currently being displayed to be rated. The rating refers to setting rating information (evaluation ranking information), which allows for the evaluation ranking of the captured image 35 to be recognized, and then adding the rating information to an image file (data file) of the captured image 35. Hereafter, the phrase “adding information to the image file of the captured image 35” may also be referred to as “setting the information for the captured image 35”. When the screen 15a of the monitor 15 is switched to the rating screen, an additional information display section 36, which is a belt-shaped area, appears in the left corner of the screen. The display section 36 is superimposed on the displayed image as shown in FIG. 3.

When the screen 15a of the monitor 15 is the rating screen, the rating setting dial 17 is turned to perform rating on the captured image 35 that is currently displayed and to perform a deletion candidate designation process, which is a non-rating process that differs from the rating, on the captured image 35 displayed on the screen. In the present embodiment, the deletion candidate designation process refers to the addition of non-rating processing information, which differs from the rating information, to the image file of the captured image 35 during the rating, or more specifically, to the addition deletion candidate designation information allowing for the captured image 35 to be recognized as a deletion candidate image (deletion candidate file).

The rating setting dial 17 is turned from an origin position in a first direction (clockwise in FIG. 1) when rating the captured image 35. This operation is referred to as a first operation. The value of the rating information set for the captured image 35 subject to processing can be changed in according with the turning angle of the rating setting dial 17. When a deletion candidate designation process is performed on the captured image 35 during rating, the rating setting dial 17 is turned from the origin position in a second direction (counterclockwise in FIG. 1). This operation is referred to as a second operation. In the present embodiment, deletion candidate designation information is set for the captured image 35 displayed on the screen 15a when the rating setting dial 17 is turned in the second direction by a predetermined angle (for example, 90 degrees) from the origin position.

The mode switch button 18 is pushed to mainly switch the mode of the camera 11 between the image capturing mode and the reproduction mode. The select button 19 is pushed when a plurality of menu items are displayed on the screen 15a to move a cursor 39 and designate a desired menu item from of the monitor 15 (refer to FIGS. 6 to 9). The enter button 20 is pushed when entering the item designated by the cursor 39 on the screen 15a of the monitor 15 and set the item as a processing subject or to enter a value of the rating information that can be freely changed during rating.

The menu button 21 is pushed to display a menu screen used to set the functions or the like of the camera 11 on the screen 15a of the monitor 15. The delete button 22 is pushed to delete the captured image displayed on the screen 15a of the monitor 15 (more specifically, delete an image file of a captured image from a memory means).

The internal structure of the camera 11 will now be described with reference to the block diagram of FIG. 2.

As shown in FIG. 2, the camera 11 includes a lens unit 23 and an image sensor 24, which are accommodated in the camera unit 12. The lens unit 23 is formed by a plurality of lenses including a zoom lens (FIG. 2 only shows a single lens to simplify the drawing). The image sensor 24 forms an image at the image space side of the lens unit 23 using the captured subject light that passes through the lens unit 23. The image sensor 24 includes an output terminal connected in series to an analog front end (AFE) 25 and an image processing circuit 26. The image processing circuit 26 is connected to a micro-processing unit (MPU) 27 by a data bus 28.

A nonvolatile memory 29, a random-access memory (RAM) 30, a monitor 15, and a card interface (IF) 32 are connected to the MPU 27 by the data bus 28. The nonvolatile memory 29 stores control programs for the camera 11. A memory card 31 functioning as a recording medium can be inserted into the card IF 32. The MPU 27 centrally controls processing performed in the camera 11 (for example, image processing performed by the image processing circuit 26) based on the programs stored in the nonvolatile memory 29 including an image processing program. The data bus 28 functions as a transmission path for transmitting the data associated with such control executed by the MPU 27. The buttons 13, 14, and 16 to 22 are also connected to the MPU 27 so that data communication can be performed between these buttons and the MPU 27. For example, the MPU 27 can detect the turning direction and the turning angle of the rating setting dial 17 based on a signal provided from the rating setting dial 17. The MPU 27 controls various circuits including the image processing circuit 26 based on signals provided from the buttons 13, 14, and 16 to 22.

The image sensor 24 is formed by, for example, a complementary metal oxide semiconductor (CMOS) image sensor or a charge coupled device (CCD) image sensor. The incident surface of the image sensor 24, or the image capturing surface, may include an array of a large number of two-dimensionally arranged light receiving elements (not shown) and the primary colors filters (not shown) for red (R), green (G), and blue (B) arranged regularly in correspondence with the surface of the array of light receiving elements. The image sensor 24 accumulates signal charge corresponding to the image of a subject formed on the image capturing surface and provides the AFE 25 with an analog pixel signal representing the accumulated signal charge used to form image data.

The AFE 25 includes a signal processing unit (not shown) and an A/D conversion unit (not shown). The signal processing unit samples the analog pixel signal provided from the image sensor 24 at a predetermined timing (correlated double sampling) and amplifies the sampled signal to, for example, a predetermined signal level determined based on the ISO speed. The A/D conversion unit converts the amplified pixel signal to a digital signal and generates digital image data. The AFE 25 provides the generated digital image data to the image processing circuit 26. The digital image data may be referred to as RAW data.

During the image capturing mode, the image processing circuit 26 performs various display image processes on the digital image data provided from the AFE 25, such as color interpolation, tone correction, white balance (WB) correction, and contour enhancement to generate digital data suitable for display. The image processing circuit 26 then temporarily stores the processed image data in the RAM 30 in accordance with the control of the MPU 27 and also displays the processed image data as a through-the-lens image on the monitor 15. When the shutter-release button 13 is pushed completely, the image processing circuit 26, which is controlled by the MPU 27, displays a check image corresponding to the current image data on the monitor 15. The image processing circuit 26 also performs predetermined image processing including a formatting process for JPEG compression and stores the image in the memory card 31 as an image file. The memory card 31 functions as a memory means.

During rating, rating information is set for the captured image 35 currently displayed on the screen 15a when the rating setting dial 17 is turned in the first direction from the origin position. In this case, the image processing circuit 26, controlled by the MPU 27, generates an image file associating (i.e., adding) the rating information with the image data of the captured image 35. During rating, deletion candidate designation information is set for the captured image 35 currently displayed on the screen 15a when the rating setting dial 17 is turned in the second direction from the origin position. In this case, the image processing circuit 26, controlled by the MPU 27, generates an image file associating the deletion candidate designation information with the image data of the captured image 35.

When the information associated with the image data of the captured image 35 that is reproduced and displayed by reading an image file from the memory card 31 is rating information, the image processing circuit 26 displays an evaluation ranking indication mark indicating the evaluation ranking on the screen 15a together with the captured image 35. The evaluation ranking indication mark is formed by star-shaped icons 37 (refer to FIG. 4 etc.) and the number of the star-shaped icons 37 corresponds to the rating indicated by the rating information. When the information associated with the image data of the captured image 35 that is reproduced and displayed by reading an image file from the memory card 31 is deletion candidate designation information, the image processing circuit 26 displays a deletion icon 38 having the shape of a trash box on the screen 15a together with the captured image 35. The deletion icon 38 indicates that the captured image 35 is a deletion candidate image and serves as a processing content indication mark indicating a non-rating processing content based on the non-rating processing information.

In this case, the image processing circuit 26 performs the processing as controlled by the MPU 27. Thus, the image processing circuit 26 and the MPU 27 in the present embodiment form an evaluation rank information adding means for adding the evaluation ranking information (rating information) to the image file of the captured image 35. In the present embodiment, the image processing circuit 26 and the MPU 27 also form a processing information adding means for adding the non-rating processing information (deletion candidate designation information) that is used to perform non-rating processing that differs from the evaluation ranking recognition process of the image file of the captured image 35. In the present embodiment, the image processing circuit 26 and the MPU 27, the rating setting dial 17, the delete button 22, the monitor 15 functioning as a display means, and the nonvolatile memory 29 and memory card 31 storing the evaluation information adding program and the image file form an information adding device.

A process for adding information performed by the camera 11 of the present embodiment will now be described.

When the user pushes the rating switching button 17a during the reproduction mode of the camera 11, the screen 15a of the monitor 15 is switched from the normal reproduction display screen to the rating screen as shown in FIG. 3. More specifically, the additional information display section 36, which is a belt-shaped area, appears on the screen 15a superimposed on the captured image 35. Various items of information related with the image file of the captured image 35 appear in the marginal space below the display area of the captured image 35 on the screen 15a. In the illustrated example, the file name (DSC), the file number (0112), the file format (JPEG), and the shooting date (2009/07/16), and the shooting time (10:03:59) are displayed in the space below the display area.

The additional information display section 36 will now be described. Most of the additional information display section 36 is occupied by a first display area 36a, which displays rating information. A left part of the additional information display section 36 is partially occupied by a second display area 36b, which displays non-rating processing information (in this case, deletion candidate designation information). A boundary line 36c is shown between the first display area 36a and the second display area 36b. A right part of the additional information display section 36 shows a dial icon 36d resembling the rating setting dial 17. The dial icon 36d can be a moving image that moves in accordance with the turning of the rating setting dial 17.

In the display state shown in FIG. 3, when detecting that the rating setting dial 17 has been turned in the first direction from the origin position, the MPU 27 starts rating the captured image 35 currently being displayed on the screen 15a. As shown in FIG. 4, the MPU 27 first controls the image processing circuit 26 to display a moving image showing the turning of the dial icon 36d in the additional information display section 36 on the screen 15a and also superimposes at least one star-shaped icon 37 in the first display area 36a. In the illustrated example, no star-shaped icons 37 are displayed when the rating setting dial 17 is at the origin position (refer to FIG. 3).

In the present embodiment, the number of star-shaped icons 37 superimposed in the additional information display section 36 indicates the set value of the rating information. In the illustrated example, a maximum of five star-shaped icons 37 can be displayed when the rating setting dial 17 is in a ranged toward the first direction from the origin position. When, for example, the MPU 27 detects that the rating setting dial 17 has been turned clockwise, or in the first direction, the MPU 27 controls the image processing circuit 26 to increase the number of displayed star-shaped icons 37 within a range of a minimum of one to a maximum of five icons. When detecting that the rating setting dial 17 has been turned in the second direction in the range toward the first direction from the origin position, the MPU 27 controls the image processing circuit 26 to decrease the number of displayed star-shaped icons 37 within a range of a minimum of one to a maximum of five icons. In the present embodiment, when the rating setting dial 17 is turned in the first direction from the origin position, the display area occupied by the star-shaped icons 37 in the first display area 36a of the additional information display section 36 expands in the sideward direction (predetermined direction). The MPU 27 thus functions as a display control means for changing the size of the display area on the screen 15a occupied by the star-shaped icons 37 in the sideward direction in accordance with the level of the evaluation ranking indicated by the rating information set for the captured image 35. In the illustrated example, whenever the rating setting dial 17 is turned by 72 degrees, the number of star-shaped icons 37 is changed by one thereby expanding or reducing the display area occupied by the star-shaped icons 37.

When the enter button 20 is pushed after the rating setting dial 17 is turned, the MPU 27 sets a value corresponding to the current turning angle of the rating setting dial 17 as the rating information for the captured image 35 displayed on the screen 15a. The image processing circuit 26 then adds the rating information to the image file. In FIG. 4, for example, the enter button 20 is pushed when the rating setting dial 17 has been turned in the first direction by 216 degrees from the origin position. In this case, the three star-shaped icons 37 corresponding to the turning angle (216 degrees) are displayed as the rating information.

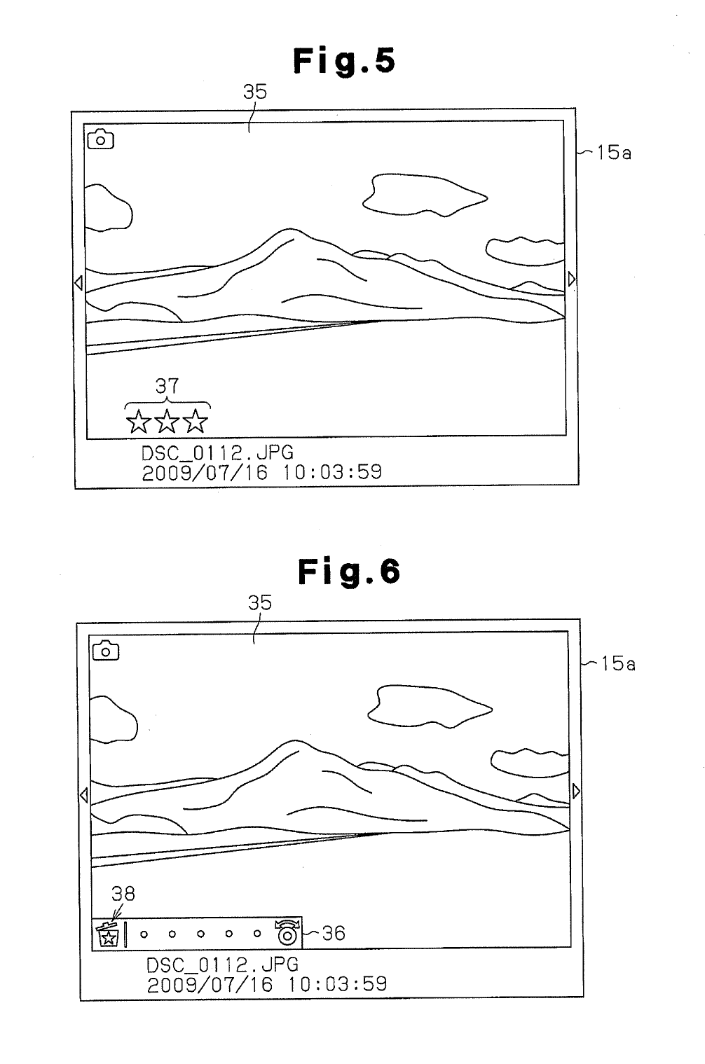

In this manner, the image processing circuit 26, which is controlled by the MPU 27, generates an image file that associates the rating information (in this case, the evaluation ranking value indicated by the three star-shaped icons 37) with the image data of the captured image 35. The image processing circuit 26 also stores the generated image file in the memory card 31. Subsequently, the image processing circuit 26, which is controlled by the MPU 27, stops displaying the belt-shaped additional information display section 36 on the screen 15a as shown in FIG. 5, and superimposes the three star-shaped icons 37, which correspond to the rating information set for the captured image 35, on the captured image 35 in the screen 15a.

When performing rating, the user may find a captured image that he or she wishes to delete. When, for example, the user wishes to delete the captured image 35 in the display state shown in FIG. 3, the user turns the rating setting dial 17 in the second direction while the rating screen remains displayed. When the rating setting dial 17 is turned by a predetermined angle (for example, 90 degrees) in the second direction from the origin position, the image processing circuit 26, which is controlled by the MPU 27, superimposed the deletion icon 38, which resembles the shape of a trash box, on the second display area 36b of the additional information display section 36 in the screen 15a as shown in FIG. 6. In the present embodiment, when the rating setting dial 17 is turned in the second direction from the origin position, the deletion icon 38 is superimposed on the second display area 36b, which is adjacent to the left side of the first display area 36a in the additional information display section 36. The origin position may be referred to as a position corresponding to the lowest evaluation ranking. When the enter button 20 is pushed in the display state shown in FIG. 6, deletion candidate designation information is set for the captured image 35, which is currently displayed on the screen 15a. The set deletion candidate designation information is then added to the image file.

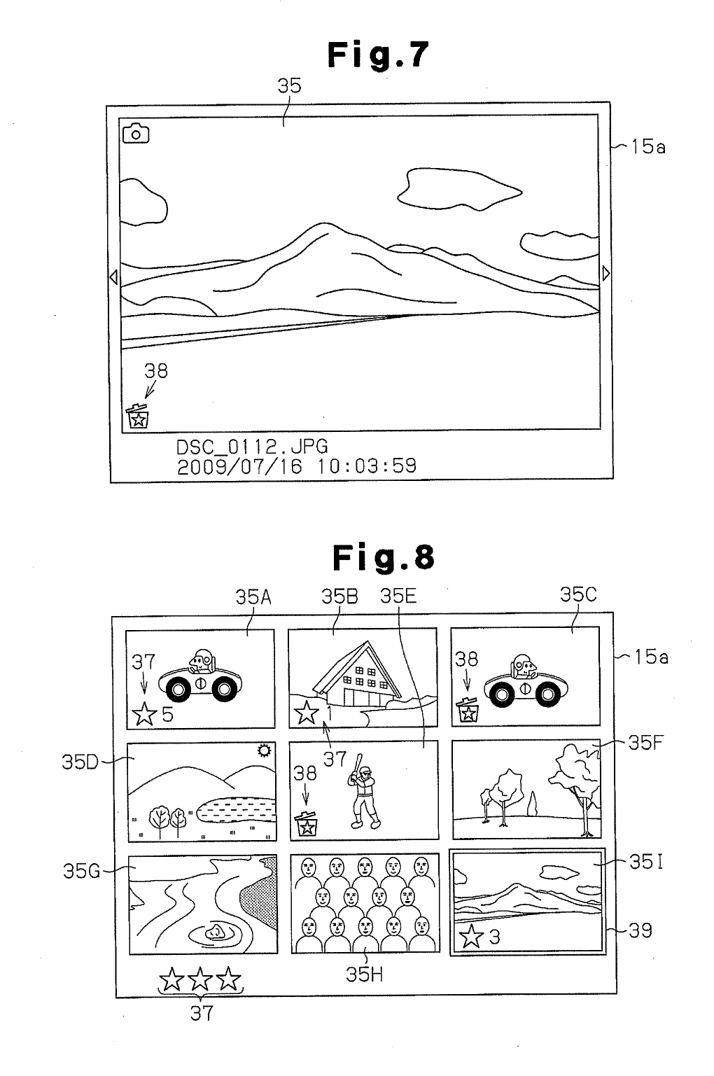

More specifically, the image processing circuit 26, which is controlled by the MPU 27, generates an image file that associates the deletion candidate designation information with the image data of the image data of the captured image 35 and stores the generated image file in the memory card 31. As shown in FIG. 7, the image processing circuit 26, which is controlled by the MPU 27, subsequently stops displaying the belt-shape additional information display section 36 on the screen 15a and superimposes the deletion icon 38, which resembles the shape of a trash box and corresponds to the deletion candidate designation information set for the captured image 35, on the captured image 35 in the screen 15a.

When the zoom button 16 is pushed in the reduction direction in the display state shown in FIG. 5 or 7, the MPU 27 controls the image processing circuit 26 to display, for example, an array of thumbnail images 35A to 35I set out in rows and columns on the screen 15a of the monitor 15 as shown in FIG. 8. The thumbnail images 35A to 35I function as a plurality of data file marks respectively corresponding to a plurality of (nine in FIG. 8) captured images. Under the display area occupied by the thumbnail images 35A to 35I on the screen 15a, rating information (in this case, the three star-shaped icons 37) set for the captured image selected by the cursor 39 (the thumbnail image 35I in the bottom-right corner) is displayed.

Among the thumbnail images 35A to 35I displayed on the screen 15a of the monitor 15, rating information or deletion candidate designation information is set for the thumbnail images 35A, 35B, 35C, 35E, and 35I. For these thumbnail images, the set information is displayed in the bottom-left corner of the display area of each thumbnail image. More specifically, the star-shaped icon 37 and a numerical value indicating the number of star-shaped icons 37 are superimposed on each of the thumbnail images (the thumbnail images 35A, 35B, and 35I in FIG. 8) corresponding to the captured images 35 for which the rating information has been set. The deletion icon 38 is superimposed on each of the thumbnail images (the thumbnail images 35C and 35E in FIG. 8) corresponding to the captured images 35 for which the deletion candidate designation information has been set. Neither the star-shaped icon 37 nor the deletion icon 38 is superimposed on the thumbnail images corresponding to the captured images 35 for which neither the rating information nor the deletion candidate designation information has been set (the thumbnail images 35D, 35F, 35G, and 35H in FIG. 8).

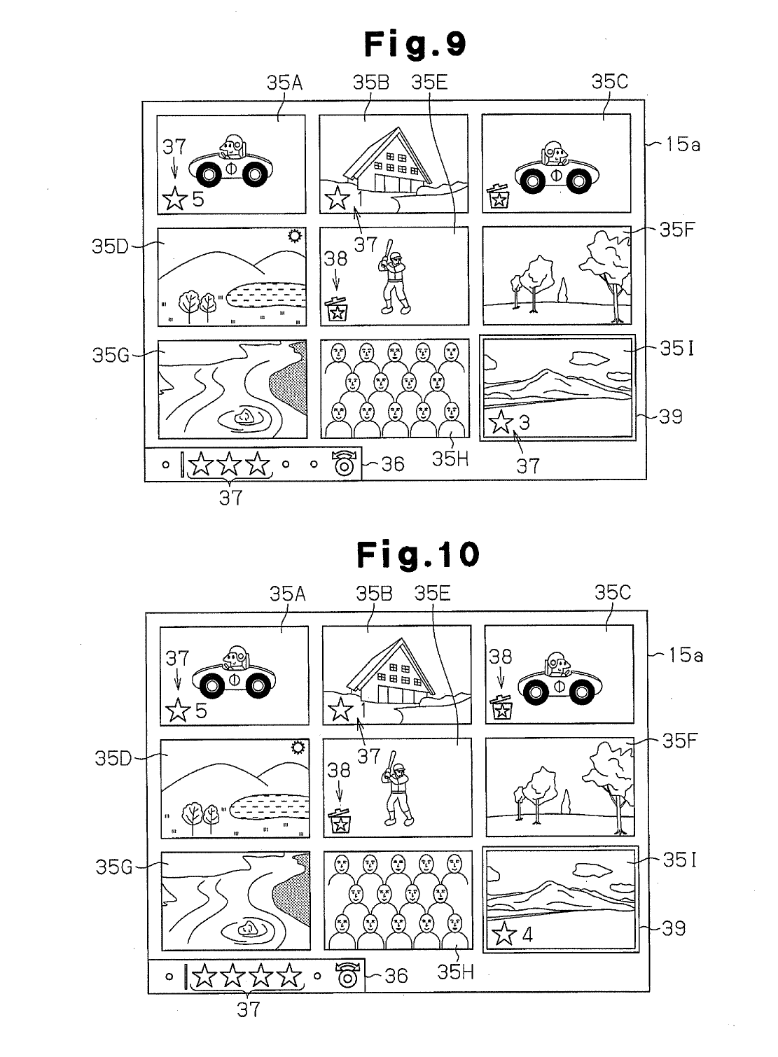

When the rating switching button 17a is pushed in the display state shown in FIG. 8, the MPU 27 controls the image processing circuit 26 to display the belt-shape additional information display section 36 below the display area occupied by the thumbnail images 35A to 35I on the screen 15a of the monitor 15 as shown in FIG. 9. When the rating setting dial 17 is turned in this state, the MPU 27 changes the rating information set for the captured image 35 corresponding to the thumbnail image currently selected by the cursor 39 (in this case, the thumbnail image 35I in the bottom-right corner). This allows the user to compare the values of the rating information set for the plurality of thumbnail images 35A to 35I and determine the appropriateness of the rating information that has been set for the captured image 35 corresponding to the thumbnail image currently selected by the cursor 39.

When, for example, the rating setting dial 17 is further turned by 72 degrees in the first direction in the display state shown in FIG. 9 and reaches the position of 288 degrees in the first direction from the origin position, the MPU 27 controls the image processing circuit 26 to change the number of star-shaped icons 37, which indicate the value of the rating information, displayed in the additional information display section 36 on the screen 15a of the monitor 15 to four star-shaped icons 37. When the enter button 20 is pushed in the display state shown in FIG. 10, the MPU 27 updates the rating information of the captured image 35 corresponding to the thumbnail image selected by the cursor 39 on the screen 15a (the thumbnail image 35I in the bottom-right corner in this case) with the value corresponding to the current turning angle of the rating setting dial 17.

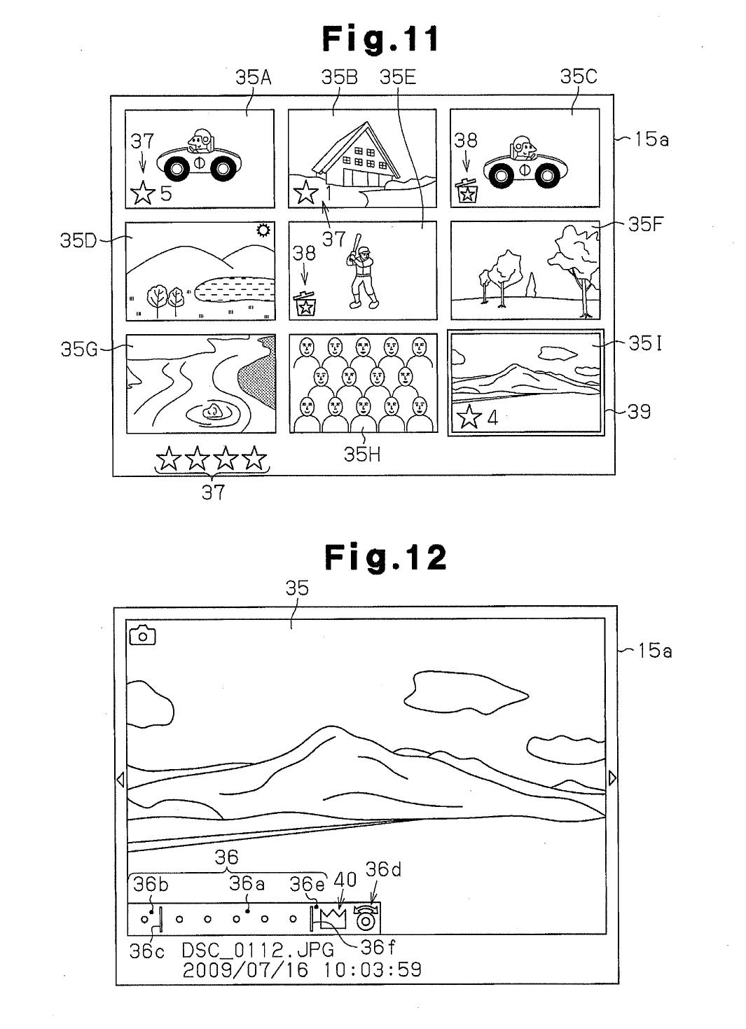

For example, the image processing circuit 26, which is controlled by the MPU 27, generates an image file that associates the updated rating information with the image data of the captured image 35 corresponding to the thumbnail image (in this case, the thumbnail image 35I in the bottom-right corner) and stores the generated image file in the memory card 31. As shown in FIG. 11, the MPU 27 subsequently stops displaying the belt-shaped additional information display section 36 on the screen 15a. As a result, four star-shaped icons 37 indicating the updated rating information for the captured image 35 corresponding to the thumbnail image currently selected by the cursor 39 (the thumbnail image 35I in the bottom-right corner in this case) appear on the screen 15a together with the thumbnail images 35A to 35I.

In the display state shown in FIG. 9, when the rating setting dial 17 is turned to a position located 90 degrees in the second direction from the origin position, the MPU 27 controls the image processing circuit 26 to stop displaying the star-shaped icons 37 in the additional information display section 36. The image processing circuit 26 then superimposes the deletion icon 38, which resembles the shape of a trash box indicating the deletion candidate designation information, on the additional information display section 36 and superimposes the deletion icon 38 on the bottom-left corner of the thumbnail image currently selected by the cursor 39 (in this case, the thumbnail image 35I in the bottom-right corner).

When the zoom button 16 is further pushed in the reduction direction in the display state shown in FIG. 8 or 11, the MPU 27 controls the image processing circuit 26 to display more thumbnail images on the screen 15a of the monitor 15 than the thumbnail images displayed just before the pushing. The MPU 27 may display the thumbnail images in an array set out in rows and columns. When the zoom button 16 is pushed in a magnification direction, the MPU 27 controls the image processing circuit 26 to reduce the number of thumbnail images displayed on the screen 15a of the monitor 15 either gradually or step by step. As a result, the display may return to the single captured image 35 as shown in FIG. 5.

In the present embodiment, in response to a signal indicating that the delete button 22 has been pushed in the display state shown in FIG. 8 or 11, the MPU 27 controls the image processing circuit 26 and deletes all of the captured images 35 corresponding to the thumbnail images in which the deletion icons 38 are superimposed on the screen 15a of the monitor 15 (the thumbnail images 35C and 35E in this case). This allows the user to compare the listed thumbnail images 35A to 35I and determine whether or not to delete the captured images 35 corresponding to the thumbnail images 35C and 35E on which the deletion icons 38 are superimposed.

The present embodiment has the advantages described below.

(1) In a state in which the captured image 35 is displayed on the screen 15a of the monitor 15, when the first operation is performed and the rating setting dial 17 is turned in the first direction from the origin position, the MPU 27 increases the number of star-shaped icons 37 indicating the evaluation ranking set for the captured image 35. When the second operation is performed and the rating setting dial 17 is turned in the second direction from the origin position (position corresponding to the lowest evaluation ranking), the MPU 27 superimposes the deletion icon 38 on the screen 15a of the monitor 15. In this manner, the series of turning operations performed with the rating setting dial 17 allows the rating information (evaluation ranking information), which is used to execute recognition processing on the captured image 35, and the non-rating processing information, which is used to perform non-rating processing that differs from the recognition processing on the captured image 35, to be promptly and easily added to the image file (data file) of the captured image 35 subject to processing.

(2) While the user is setting the rating information as the evaluation ranking information for the plurality of captured images 35, the user may find a captured image 35 that he or she wishes to delete. In such a case, the user performs a series of turning operations on the rating setting dial 17 to readily add the deletion candidate designation information instead of the rating information to the captured image 35 that he or she wishes to delete. The one or more captured images 35 to which the deletion candidate designation information has been added can be specified based on the deletion candidate designation information. This allows the user to delete the captured images 35 that he or she wishes to do so without failing to find such captured images 35 even when a long period of time elapses such as when the user switches the screen from the rating screen to another screen after setting the deletion candidate designation information.

(3) The rating setting dial 17, which functions as operating means, is commonly used to set (add) the rating information to the captured image 35 displayed on the rating screen and to set (add) the deletion candidate designation information to the captured image 35. This eliminates the need to switch screens on the monitor 15 and simplifies the operations for setting (adding) the rating information and the deletion candidate designation information.

(4) The size of the display area for the star-shaped icons 37 in the additional information display section 36 is changed in accordance with the rating information set for the captured image 35. The deletion icon 38 is displayed at a position adjacent to the display area of the star-shaped icons 37 in the additional information display section 36. Thus, the user can view the star-shaped icons 37 or the deletion icon 38 displayed in the additional information display section 36 and can easily recognize whether the information added to the image file of the captured image 35 on the screen 15a is rating information or deletion candidate designation information.

(5) In a state in which the thumbnail images 35A to 35I of the captured images 35 that are the images subject to rating are listed on the screen 15a of the monitor 15, the rating information or the deletion candidate designation information is set for the captured image 35 corresponding to the thumbnail image currently selected by the cursor 39 (for example, the image 35I). Thus, the user can determine whether or not to add the rating information or the deletion candidate designation information to the captured image 35 corresponding to the thumbnail image (35I) currently selected by the cursor 39, while comparing the information set for the plurality of captured images 35 on the screen 15a of the monitor 15.

The above embodiment may be modified in the following forms.

In the above embodiment, the additional information display section 36 may further include a third display area 36e shown in FIG. 12 according to a first modification of the embodiment. The third display area 36e is defined adjacent to the right side of the first display area 36a, and separated from the first display area 36a by a boundary line 36f. The third display area 36e may display an icon as one or more processing content indication marks selected from the processes described below.

For example, in a state in which five star-shaped icons 37 are displayed in the additional information display section 36, when the rating setting dial 17 is further turned in the first direction, the MPU 27 may control the image processing circuit 26 to display an icon 40 resembling the shape of a crown superimposed in the third display area 36e of the additional information display section 36. The crown icon 40 is an upper grade icon indicating that the added evaluation ranking information is a single grade higher than the normal setting level of the star-shaped icons 37 for the rating information set for the captured image.

For example, in a state in which five star-shaped icons 37 are displayed in the additional information display section 36, when the rating setting dial 17 is further turned in the first direction, the MPU 27 may control the image processing circuit 26 to superimpose a printing icon (not shown) in the third display area 36e of the additional information display section 36. The printing icon indicates that non-rating processing information has been added to execute printing using a printer connected to the camera 11 by a USB cable or the like by automatically reading the image file of the captured image 35 currently subject to processing from the memory card 31.

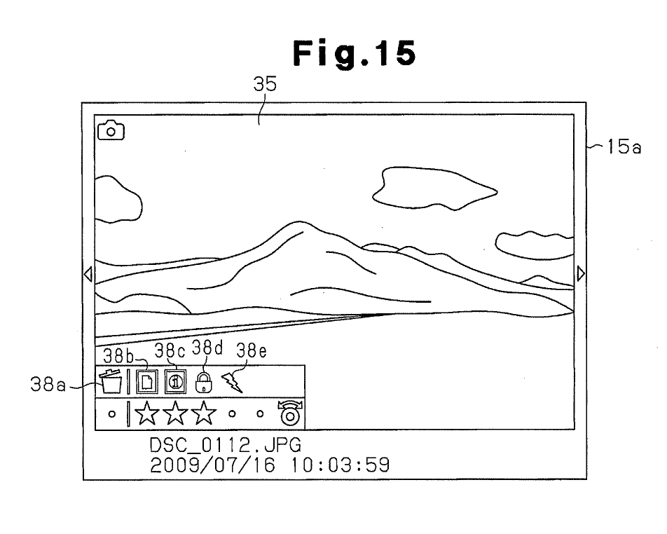

For example, in a state in which five star-shaped icons 37 are displayed in the additional information display section 36, when the rating setting dial 17 is further turned in the first direction, the MPU 27 may control the image processing circuit 26 to superimpose a protection icon (refer to protection icon 38d in FIG. 15) on the third display area 36e of the additional information display section 36. The protection icon indicates that non-rating processing information has been added to nullify the deletion processing when deletion is executed on the captured image 35 currently subject to processing.

For example, in a state in which five star-shaped icons 37 are displayed in the additional information display section 36, when the rating setting dial 17 is further turned in the first direction, a transfer icon (not shown) may be superimposed on the third display area 36e of the additional information display section 36. The transfer icon indicates that processing information has been added to automatically read the image file of the captured image 35, which is currently subject to processing, from the memory card 31 and transfer the read image file to an external device (personal computer or the like) when the camera 11 is connected to the external device by a USB cable.

In each of the above configurations, the series of turning operations of the rating setting dial 17 readily and easily add the rating information (evaluation ranking information), which is used to execute the recognition processing on the captured image 35, and the non-rating processing information (i.e., the printing information, the protection information, and the transfer information), which is used to perform processing that differs from the evaluation ranking determination, to the image file (data file) of the captured image 35 subject to processing.

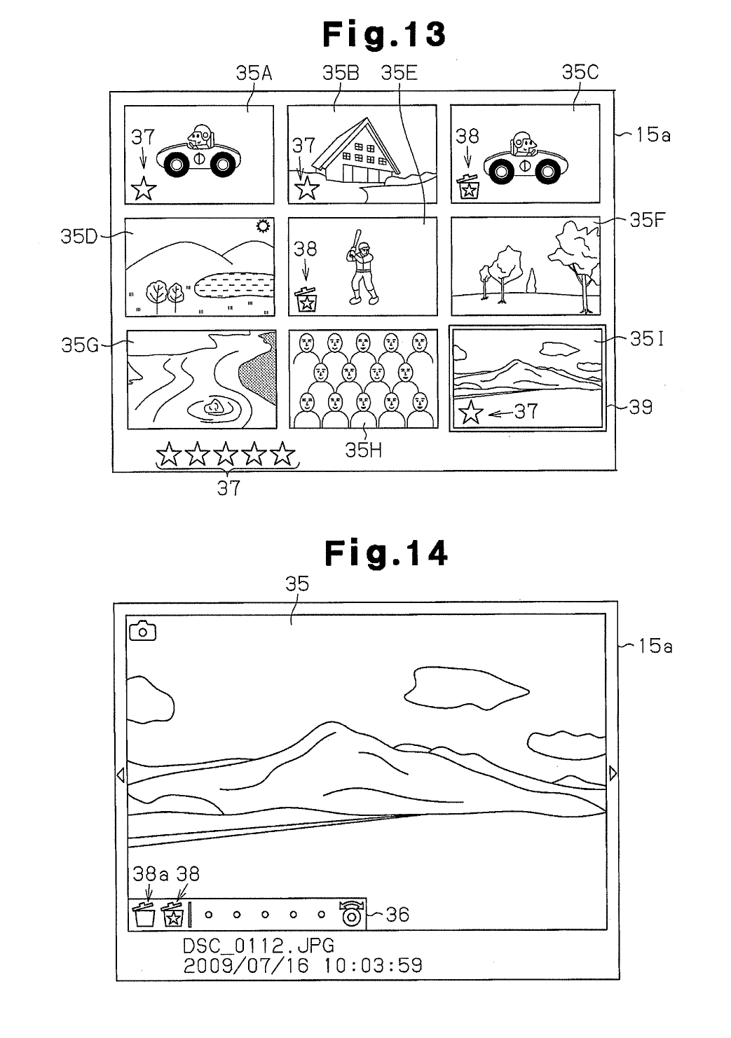

When the thumbnail images 35A to 35I are listed in the screen 15a of the monitor 15 in the above embodiment, just the star-shaped icon 37 may be superimposed on the screen 15a of the monitor 15 like in a second modification shown in FIG. 13, and the value indicating the number of star-shaped icons 37 may be eliminated. In the example shown in FIG. 13, five star-shaped icons 37, which function as the rating information for the thumbnail image 35I selected by the cursor 39, are displayed in the area outside the area displaying the thumbnail images. This configuration obtains a sufficient display area for the star-shaped icons 37 superimposed on the thumbnail images 35A to 35I even when displaying the plurality of thumbnail images 35A to 35I on the relatively small screen 15a. This allows the user to easily determine whether the setting of the rating has been completed for the captured images 35 corresponding to the thumbnail images 35A to 35I.

In the above embodiment, the set state of the rating information or the deletion candidate designation information does not have to be indicated by the star-shaped icon 37 or the deletion icon 38 resembling the shape of a trash box and may be indicated by an icon having any other shape. For example, a bar extending in the sideward direction may be superimposed on the additional information display section 36 to indicate the evaluation ranking of the rating information set for each captured image 35. The length of the displayed bar may be increased or decreased in accordance with the evaluation ranking indicated by the rating information. In another example, the setting of the rating information may be indicated just by a numerical value representing the evaluation ranking of the rating information.

In the above embodiment, the captured images 35 to which the deletion candidate designation information has been set may be automatically deleted from the memory card 31 by the MPU 27 when the storage space of the memory card 31 becomes insufficient. It is preferable that a selection screen asking whether or not the captured image 35 to which the deletion candidate designation information has been set can be deleted from the memory card 31.

In the above embodiment, the rating information set for the captured image 35 may be changed by pushing the select button 19 in a state in which the captured image 35 is displayed on the rating screen. In this case, the rating setting dial 17 used to change the rating information set for the captured image 35 may be eliminated.

In the above embodiment, an operating member icon used to change the rating information that is set for the captured image 35 may be displayed on the screen 15a of the monitor 15. The rating information set for the captured image 35 may be changed by pushing the operating member icon on the screen 15a.

In the above embodiment, when setting the deletion candidate designation information for the captured image 35, the amount by which the operating member is operated from the position indicating the lowest evaluation ranking may be either be substantially the same or be different from the amount by which the operating member is operated to decrease a single star-shaped icon 37. When the rating setting dial 17 is used as the operating member, the amount by which the operating member is operated is set as the turning angle of the rating setting dial 17. When the select button 19 is used as the operating member, the amount by which the operating member is operated is set as the number of times the select button 19 is pushed.

In the same manner, when setting the non-rating processing information for the captured image 35, the amount by which the operating member is operated from the position indicating the highest evaluation ranking may be substantially the same or be different from the amount by which the operating member is operated to increase a single star-shaped icon 37.

In the above embodiment, the deletion icon 38, which functions as a processing content indication mark, indicates that the captured image 35 is a deletion candidate image. Alternatively, the deletion icon 38 may indicate that the captured image 35 is to be deleted. For example, when the enter button 20 is pushed in a state in which the deletion icon 38 is displayed in the additional information display section 36, the MPU 27 adds, to the data file of the captured image 35, the deletion selection information allowing the data file of the captured image 35 to be recognized as the file that is to be deleted on the screen 15a, and then starts deleting the captured image 35. Before deleting the image, a message confirming whether the image can be deleted may be displayed.

In the above embodiment, in addition to the deletion icon 38 indicating that the captured image 35 is a deletion candidate image, a further deletion execution icon 38a, which deletes the captured image 35, may be displayed in the additional information display section 36 like in a third modification shown in FIG. 14. The deletion execution icon 38a is one example of a processing content indication mark. In a non-restrictive example, the deletion execution icon 38a may be displayed in the second display area 36b of the additional information display section 36 at the left side of the deletion icon 38. In this case, when the deletion icon 38 is displayed and the rating setting dial 17 is turned in the second direction by a predetermined angle (for example, 360 degrees), the MPU 27 controls the deletion execution icon 38a to appear in the additional information display section 36, and the deletion selection information allowing for the data file of the captured image 35 to be recognized as a file that is to be deleted is added to the data file. Before deleting the image, a message confirming whether the image can be deleted may be displayed.

In the above embodiment, when the MPU 27 detects that a third operation has been performed in a state in which the deletion icon 38 indicating that the captured image 35 is a deletion candidate image is displayed in the additional information display section 36 as shown in FIG. 6, a state in which the deletion icon 38 is displayed in the captured image 35 as shown in FIG. 7, or in a state in the deletion icon 38 is displayed on the thumbnail image 35E as shown in FIG. 8, the MPU 27 may delete the captured image 35 (or the thumbnail image 35E). The third operation may be performed by, for example, pushing the select button 19, pushing the delete button 22, or pushing the enter button 20 for a predetermined period of time (e.g., two seconds). Alternatively, the captured image 35 may be deleted when the rating setting dial 17 is turned in the second direction by a predetermined angle (for example, 360 degrees) in a state in which the deletion icon 38 is displayed in the additional information display section 36. Before deleting the image, a message confirming whether the image can be deleted may be displayed.

In the above embodiment, when the delete button 22 is pushed once during rating, the deletion icon 38 indicating that the captured image 35 is a deletion candidate image may be displayed in the additional information display section 36. When the delete button 22 is pushed twice during rating, the captured image 35 may be deleted. Before deleting the image, a message confirming whether the image can be deleted may be displayed.

In the above embodiment, the additional information display section 36 may display information in a plurality of rows instead of a single row. In a fourth modification shown in FIG. 15, the additional information display section 36 is divided into a first row, or lower row, and a second row, or upper row. In the first row, the star-shaped icons 37 and the deletion icon 38 can be displayed in the same manner as in the additional information display section 36 shown in FIG. 3 or FIG. 12. The second row can display one or more processing content indication marks including the deletion execution icon 38a, which executes deletion, the printing icon 38b, which indicates printing information, an icon 38c, which indicates image information (shooting date and time, shooting location, and the like), the protection icon 38d, which indicates protection information, and the transfer icon 38e, which indicate transfer information. In the illustrated example, the deletion execution icon 38a is selected when the rating setting dial 17 is turned in the second direction by the predetermined angle (for example, 360 degrees) in a state in which the deletion icon 38 is displayed in the additional information display section 36. When the MPU 27 detects that the rating setting dial 17 located at the position indicating the highest evaluation ranking is further turned in the first direction, the icons 38b to 38e are sequentially selected.

The additional information display section 36 may include a plurality of rows shown at the same time or shown one by one in order or in a switched manner when the operating member is operated. For example, in a state in which a first row of the additional information display section 36 is displayed, when an operation member such as the select button 19 is operated, the additional information display section 36 may be scrolled to display another row.

The additional information display section 36 of the above embodiment may display the printing icon 38b, which indicates printing information, the protection icon 38d, which indicates protection information, and the transfer icon 38e, which indicates transfer information (refer to FIG. 15). In a non-restrictive example, the three icons 38b, 38d, and 38e may be displayed at the right side of the first display area 36a, which displays the evaluation ranking indication mark (for example, the third display area 36e shown in FIG. 12). To select the icons 38b, 38d, and 38e, the rating setting dial 17 only needs to be turned in the first direction during rating. When one of the three icons 38b, 38d, and 38e is selected, the display of the rating information (evaluation ranking indication mark) may disappear.

In the above embodiment, when thumbnail images are displayed as shown in FIG. 9, a plurality of thumbnail images may be selected, and the selected thumbnail images may be provided with the same rating through a single operation. Further, the selected plurality of images may be provided with the same non-rating processing information through a single operation. For example, the user can select a plurality of images by operating a selection means, such as the select button 19 and the enter button 20. When the user operates the rating setting dial 17 in this state, the desired evaluation ranking indication mark or the desired processing content indication mark is added to each of the selected images.

In the above embodiment, images to which the rating information with the same evaluation ranking has been added may be extracted and reproduced. The images with the same evaluation ranking may be reproduced one after another or be displayed as a list of thumbnail images. Further, a tab may be provided for each evaluation ranking, and the tab may be displayed on the screen 15a so that the user can select the tab and display the corresponding images having the same evaluation ranking.

In the above embodiment, the LCD monitor 15 may be a touch panel that functions as the operating member. In this case, the MPU 27 may set the rating information in accordance with the movement of a finger on the touch panel. In one example, the touch panel may output a signal indicating the movement of one or more fingers on the touch panel, and the MPU 27 may set the rating information in accordance with the signal provided from the touch panel. For example, the MPU 27 may perform processing to raise the evaluation ranking when the finger on the touch panel is turned in the first direction and may perform processing to lower the evaluation ranking when the finger is turned in the second direction.

The MPU 27 may set the non-rating processing information in accordance with the movement of a finger on the touch panel. For example, when a captured image 35 or a thumbnail image is dragged to the deletion icon 38 on the touch panel, the deletion candidate image processing may be performed on the image. In another example, when tapping of the deletion icon 38 is detected after dragging of a captured image 35 or a thumbnail image to the deletion icon 38 is detected, the MPU 27 may start deletion of the image. In a further example, in a state in which a captured image 35 or thumbnail image selected as a deletion candidate image is displayed, when tapping of the image or the deletion icon is detected, the deletion of the image may be started.

In the above embodiment, the MPU 27 of the camera 11 may be connected to a large-screen display device, such as a high-definition television, by, for example, a USB line or the like so that information related with image processing and control information can be communicated. In this case, the rating information and the non-rating processing information may be set for a captured image on the large screen of the display device based on the information of the image file for the captured image transmitted from the camera 11 to the display device.

In the above embodiment, the memory card 31, which may be an SD card or the like attached in a removable manner to the camera 11, may be removed from the camera 11 and arranged in a card slot of a controller connected in an information-communicable manner to a display device, such as a high-definition television. In this case, the rating information and the non-rating processing information may be set for the captured image on the screen of the display device as controlled by the controller.

In the above embodiment, the rating information and the non-rating processing information may be added to other data files, such as a moving image file or an audio file. Other devices may be used to add the rating information and the non-rating processing information to these data files. Examples of such an information adding device include a video camera, a digital photo frame, a personal computer, a video recorder, and an audio player. More specifically, the information adding device may be any device that can add, to a data file, the rating information (evaluation ranking information) and the non-rating processing information used to perform non-rating processing that differs from the recognition processing based on the rating information. In this case, an information adding program used to perform such processing may be transferred to the device via the Internet or may be recorded on a recording medium, such as a compact disc (CD), inserted into the information adding device.

The above embodiment and the modifications may be combined with one another.

### DESCRIPTION OF REFERENCE CHARACTERS

11) digital still camera serving as electronic camera
15) monitor serving as display means
15a) screen
17) rating setting dial serving as operating means
19) select button serving as selection means
24) image sensor serving as imaging means
26) image processing circuit forming evaluation information adding means and processing information adding means
27) MPU forming evaluation information adding means and processing information adding means
35) captured image serving as data file
35A to 35I) thumbnail image serving as data file mark
36) additional information display section
37) star-shaped icon serving as evaluation ranking indication mark
38) deletion icon serving as processing content indication mark
38a to 38e and 40) icon serving as processing content indication mark

1. An information adding device comprising:
an evaluation ranking information adder for setting evaluation ranking information for a data file, wherein the evaluation ranking information can be used in recognition processing of an evaluation ranking of the data file, wherein the evaluation ranking information adder performs rating processing to raise the evaluation ranking in response to a first operation, performs rating processing to lower the evaluation ranking in response to a second operation that differs from the first operation, and adds evaluation ranking information to the data file in accordance with the result of the rating processing performed; and
a processing information adder for adding non-rating processing information to the data file when the first operation is further performed in a state in which the evaluation ranking is a highest ranking or when the second operation is further performed in a state in which the evaluation ranking is a lowest ranking, wherein the non-rating processing information is used to perform non-rating processing that differs from the recognition processing of the evaluation ranking.

2. The information adding device according to claim 1, wherein the processing information adder adds deletion candidate designation information as the non-rating processing information to the data file when the second operation is performed in a state in which the evaluation ranking is the lowest evaluation ranking, wherein the deletion candidate designation information allows for the data file to be recognized as a deletion candidate file.

3. The information adding device according to claim 1 or 2, wherein the processing information adder adds deletion designation information as the non-rating processing information to the data file when the second operation is performed in a state in which the evaluation ranking is the lowest evaluation ranking, wherein the deletion designation information allows for the data file to be recognized as a deletion file.

4. The information adding device according to claim 2, wherein the data file is deleted when a third operation is further performed for the data file to which the deletion candidate designation information has been added.

5. The information adding device according to claim 1, wherein the processing information adder adds protection information or transfer information as the non-rating processing information to the data file when the first operation is performed in a state in which the evaluation ranking is the highest evaluation ranking, the protection information indicates that the data file is a file subject to protection, and the transfer information indicates that the data file is subject to transfer to an external device.

6. The information adding device according to claim 1, wherein
the data file is an image file, and
the processing information adder adds printing information as the non-rating processing information to the data file when the first operation is performed in a state in which the evaluation ranking is the highest evaluation ranking, wherein the printing information indicates that the data file is subject to printing.

7. The information adding device according to claim 1, further comprising an operating member that is turned to perform the first operation and the second operation, wherein
the first operation is an operation that turns the operating member in a first direction, and the second operation is an operation that turns the operating member in a second direction.

8. The information adding device according to claim 1, further comprising:
a display including a screen that can display an evaluation ranking indication mark indicating the evaluation ranking and a processing content indication mark corresponding to the non-rating processing information; and
a display controller for changing a size of a display area of the evaluation ranking indication mark on the screen in a predetermined direction in accordance with the evaluation ranking and for displaying the processing content indication mark at a position adjacent to the display area of the evaluation ranking indication mark in the predetermined direction.

9. The information adding device according to claim 8, wherein
the display is a touch panel, and
the evaluation ranking information adder and the processing information adder detect the first operation and the second operation based on a signal provided from the touch panel in correspondence with movement of a finger on the touch panel.

10. The information adding device according to claim 8, wherein the display displays an additional information display section that displays the evaluation ranking indication mark and the processing content indication mark in a single row or in a plurality of rows.

11. The information adding device according to claim 10, wherein the additional information display section displays the evaluation ranking indication mark and the processing content indication mark in a single row.

12. The information adding device according to claim 10, wherein the additional information display section includes a plurality of rows that can display the evaluation ranking indication mark and a plurality of processing content indication marks respectively corresponding to a plurality of non-rating processing contents.

13. The information adding device according to claim 12, wherein the plurality of rows of the additional information display section are displayed one by one in response to operation of an operating member.

14. The information adding device according to claim 12, wherein the plurality of rows of the additional information display section include a first row, which displays the evaluation ranking indication mark, and a second row, which displays at least one of the plurality of processing content indication marks.

15. The information adding device according to claim 10, wherein
the additional information display section can display a plurality of processing content indication marks respectively corresponding to a plurality of non-rating processing contents, the plurality of processing content indication marks include a printing icon, a protection icon, and a transfer icon, and
when the first operation is further performed in a state in which the evaluation ranking is the highest evaluation ranking, one of the printing icon, the protection icon, and the transfer icon is selected in accordance with an operation amount of the first operation.

16. The information adding device according to claim 8, wherein
the display can display a list of a plurality of data file marks respectively corresponding to a plurality of data files, and
the display controller displays the evaluation ranking indication mark or the processing content indication mark corresponding to a data file mark selected from the list of the plurality of data file marks displayed on the screen.

17. The information adding device according to claim 16, further comprising a selector that freely selects a plurality of data files from the list of the plurality of data file marks displayed on the screen, wherein
the evaluation ranking information adder adds the same evaluation ranking information to the selected data files, and
the processing information adder adds the same non-rating processing information to the selected data files.

18. The information adding device according to claim 1, wherein the processing information adder adds the non-rating processing information to the data file when the first operation is further performed a number of times in a state in which the evaluation ranking is the highest evaluation ranking or when the second operation is further performed a number of times in a state in which the evaluation ranking is the lowest evaluation ranking.

19. The information adding device according to claim 1, wherein the data file is an image file.

20. An electronic camera comprising:
an imaging unit that captures an image; and
the information adding device according to claim 1.

21. An information adding program executed by an information adding device configured to be able to add evaluation ranking information and non-rating processing information to a data file, wherein the evaluation ranking information allows for recognition of an evaluation ranking of the data file, and the non-rating processing information is used to perform non-rating processing that differs from a recognition processing of the evaluation ranking, the program comprising instructions causing the information adding device to execute:
an evaluation ranking information adding step including a rating process that raises the evaluation ranking in response to a first operation, a rating process that lowers the evaluation ranking in response to a second operation that differs from the first operation, and a process that adds evaluation ranking information to the data file in accordance with the result of the rating processes performed; and
a processing information adding step that adds the non-rating processing information to the data file when the first operation is further performed in a state in which the evaluation ranking is a highest evaluation rank or when the second operation is further performed in a state in which the evaluation ranking is a lowest evaluation rank.
